(19) United States
(12) Patent Application Publication
(10) Pub. No.: US 2021/0390451 A1
(43) Pub. Date: Dec. 16, 2021

(54) ANALYSIS DEVICE, MACHINE LEARNING DEVICE, ANALYSIS SYSTEM, ANALYSIS METHOD, AND RECORDING MEDIUM

(71) Applicants: NEC CORPORATION, Tokyo (JP); NATIONAL INSTITUTE OF ADVANCED INDUSTRIAl SCIENCE AND TECHNOLOGY, Tokyo (JP)

(72) Inventors: Keiichi KISAMORI, Tokyo (JP); Yuto KOMORI, Tokyo (JP); Takashi WASHIO, Tokyo (JP); Yoshio KAMEDA, Tokyo (JP)

(73) Assignees: NEC CORPORATION, Tokyo (JP); NATIONAL INSTITUTE OF ADVANCED INDUSTRIAL SCIENCE AND TECHNOLOGY, Tokyo (JP)

(21) Appl. No.: 17/288,595

(22) PCT Filed: Oct. 29, 2019
(86) PCT No.: PCT/JP2019/042402

§ 371 Date: Apr. 26, 2021

(30) Foreign Application Priority Data
Oct. 30, 2018 (JP) 2018-204014

(51) Int. Cl. G06N 20/00

(52) U.S. Cl. CPC G06N 20/00

(57) ABSTRACT

An analysis device applies, for each of a plurality of candidates set according to a update target parameter value, the update target parameter value and the candidate to a machine learning result to acquire information, the information indicating a degree of difference of an evaluation target value in a case of the candidate with respect to an evaluation target value in a case of the update target parameter value; calculates, for each candidate, an evaluation target value in a case of the candidate, based on the degree of difference of the evaluation target values and the evaluation target value in the case of the update target parameter value; and compares the evaluation target values in a case of each of the plurality of candidates and selects a candidate from the plurality of candidates based on a result of the comparison.

### TECHNICAL FIELD

The present invention relates to an analysis device, a machine learning device, an analysis system, an analysis method, and a recording medium.

### BACKGROUND ART

Several analysis techniques such as an analysis technique using simulation have been proposed.

For example, Patent Document 1 describes an extraction method for extracting a trial to be analyzed from a plurality of trials of simulation. In this extraction method, for a subject (examination subject) such as wanting to shorten a waiting time at a cash register of a store, a plurality of simulations are executed by changing measures (measures for the subject) such as the number of cash registers and a layout, and environmental elements based on elements having uncertainty such as the behavior of customers. In Patent Document 1, the execution of individual simulations is referred to as a trial. In the extraction method described in Patent Document 1, a trial having an evaluation value that is detached from that of other trials is extracted as the trial to be analyzed.

Patent Document 2 describes an event analysis device that analyzes an event occurring in a plant. This event analysis device groups events based on an event matrix that shows the presence or absence of occurrence for each event in time-series to construct a causal relationship model with probability by a Bayesian network for the obtained related event groups based on the event matrix. This event analysis device extracts a causal relationship model with probability that matches any of set improvement candidate patterns among the models with probability for each event.

Patent Document 3 describes a disposition place and disposition pattern calculation device that determines a disposition place of a base station and a disposition pattern of cells in microdiversity using a sector antenna. In this disposition place and disposition pattern calculation device, the disposition of the base station and the disposition pattern of the cells are determined under a condition that convex polygons indicating the cells are disposed on a predetermined two-dimensional plane without overlapping and gaps.

Patent Document 4 describes a determination device that improves the accuracy of image search. This determination device associates three images to be determined for relevance in a metric space and determines the relevance of the three images as an angle defined by the three images in the metric space.

### PRIOR ART DOCUMENTS

### Patent Documents

[Patent Document 1] Japanese Unexamined Patent Application, First Publication No. 2016-157173
[Patent Document 2] Japanese Unexamined Patent Application, First Publication No. 2016-099930
[Patent Document 3] Japanese Unexamined Patent Application, First Publication No. 2016-091400
[Patent Document 4] Japanese Unexamined Patent Application, First Publication No.

2017-167987

### SUMMARY OF THE INVENTION

### Problem to be Solved by the Invention

In the technique described in Patent Document 1, the simulation is repeated for each measure such as the number of cash registers and the layout, as described above. In a case where the number of measures is large, a time required to execute the simulation becomes enormous and thus it is considered that processing will not be ended in a realistic time. Therefore, in a case where the number of patterns that can be taken by an analysis target is large, such as in a case where the number of design patterns is large, the technique described in Patent Document 1 cannot be directly applied.

The technique described in Patent Document 2 is for collecting and analyzing logs of events such as “operation” and “alarm” in the plant, and the technique described in Patent Document 2 cannot be directly applied to an analysis other than the event analysis.

The technique described in Patent Document 3 is for determining the disposition pattern of the base station as a convex polygon disposition pattern, and the technique described in Patent Document 3 cannot be directly applied to another analysis.

The technique described in Patent Document 4 is for searching for an image by utilizing the relevance between images, and the technique described in Patent Document 4 cannot be directly applied to another analysis.

An example object of the present invention is to provide an analysis device, a machine learning device, an analysis system, an analysis method, and a recording medium capable of solving the above-mentioned problems.

### Means for Solving the Problem

According to a first example aspect of the present invention, an analysis device includes: difference information acquisition means for applying, for each of a plurality of candidates set according to a update target parameter value, the update target parameter value and the candidate to a machine learning result to acquire information, the information indicating a degree of difference of an evaluation target value in a case of the candidate with respect to an evaluation target value in a case of the update target parameter value; evaluation target value calculation means for calculating, for each candidate, an evaluation target value in a case of the candidate, based on the degree of difference of the evaluation target values and the evaluation target value in the case of the update target parameter value; and updated parameter value selection means for comparing the evaluation target values in a case of each of the plurality of candidates and for selecting a candidate from the plurality of candidates based on a result of the comparison, and for updating the update target parameter value and the evaluation target value in the case of the update target parameter value to the selected candidate and the evaluation target value in the case of the selected candidate, respectively.

According to a second example aspect of the present invention, a machine learning device includes: parameter value acquisition means for acquiring an update target parameter value and an updated parameter value; simulation execution means for calculating, by simulation, an evaluation target value in a case of the update target parameter value and an evaluation target value in a case of the updated parameter value; difference calculation means for calculating a degree of difference of the evaluation target value in the case of the updated parameter value with respect to the evaluation target value in the case of the update target parameter value; and machine learning processing means for performing machine learning on a relationship between: the update target parameter value and the updated parameter value; and the degree of difference of the evaluation target values.

According to a third example aspect of the present invention, an analysis system includes a machine learning device and an analysis device. The machine learning device includes: parameter value acquisition means for acquiring an update target parameter value and an updated parameter value; simulation execution means for calculating, by simulation, an evaluation target value in a case of the update target parameter value and an evaluation target value in a case of the updated parameter value; difference calculation means for calculating a degree of difference of the evaluation target value in the case of the updated parameter value with respect to the evaluation target value in the case of the update target parameter value; and machine learning processing means for performing machine learning on a relationship between: the update target parameter value and the updated parameter value; and the degree of difference of the evaluation target values. The analysis device comprises: difference information acquisition means for applying, for each of a plurality of candidates for an updated parameter value set according to an update target parameter value, the update target parameter value and the candidate to a machine learning result to acquire information, the information indicating a degree of difference of an evaluation target value in a case of the candidate with respect to an evaluation target value in a case of the update target parameter value; evaluation target value calculation means for calculating, for each candidate, an evaluation target value in a case of the candidate for a parameter value after the update based on the degree of difference of the evaluation target values and the evaluation target value in the case of the update target parameter value; and updated parameter value selection means for selecting a candidate having an evaluation target value that best matches a target among the plurality of candidates and updating the update target parameter value and the evaluation target value in the case of the update target parameter value to the selected candidate and an evaluation target value in the case of the selected candidate.

According to a fourth example aspect of the present invention, an analysis method is executed by a computer, and includes: applying, for each of a plurality of candidates set according to a update target parameter value, the update target parameter value and the candidate to a machine learning result to acquire information, the information indicating a degree of difference of an evaluation target value in a case of the candidate with respect to an evaluation target value in a case of the update target parameter value; calculating, for each candidate, an evaluation target value in a case of the candidate, based on the degree of difference of the evaluation target values and the evaluation target value in the case of the update target parameter value; comparing the evaluation target values in a case of each of the plurality of candidates; selecting a candidate from the plurality of candidates based on a result of the comparison; and updating the update target parameter value and the evaluation target value in the case of the update target parameter value to the selected candidate and the evaluation target value in the case of the selected candidate, respectively.

According to a fifth example aspect of the present invention, a recording medium stores a program for causing a computer to execute: applying, for each of a plurality of candidates set according to a update target parameter value, the update target parameter value and the candidate to a machine learning result to acquire information, the information indicating a degree of difference of an evaluation target value in a case of the candidate with respect to an evaluation target value in a case of the update target parameter value; calculating, for each candidate, an evaluation target value in a case of the candidate, based on the degree of difference of the evaluation target values and the evaluation target value in the case of the update target parameter value; comparing the evaluation target values in a case of each of the plurality of candidates; selecting a candidate from the plurality of candidates based on a result of the comparison; and updating the update target parameter value and the evaluation target value in the case of the update target parameter value to the selected candidate and the evaluation target value in the case of the selected candidate, respectively.

### Effect of the Invention

According to example embodiments of the present invention, it is possible to efficiently perform an analysis of selecting one having a high evaluation from among a plurality of patterns.

### BRIEF DESCRIPTION OF THE DRAWINGS

FIG. 1 is a schematic configuration diagram showing an example of a device configuration of an analysis system according to a first example embodiment.

FIG. 2 is a diagram showing an example of a target of an analysis by an analysis system according to the first example embodiment.

FIG. 3 is a diagram showing an example of setting a parameter in the target of the analysis by the analysis system according to the first example embodiment.

FIG. 4 is a diagram showing an example of updating a parameter value in the analysis system according to the first example embodiment.

FIG. 5 is a diagram showing an example of searching for the parameter value by an analysis device according to the first example embodiment.

FIG. 6 is a schematic block diagram showing an example of a functional configuration of a machine learning device according to the first example embodiment.

FIG. 7 is a schematic block diagram showing an example of a functional configuration of the analysis device according to the first example embodiment.

FIG. 8 is a flowchart showing an example of a processing procedure in which the machine learning device according to the first example embodiment learns a relationship between parameter values before and after the update and a ratio Y of a difference between evaluation target values.

FIG. 9 is a flowchart showing an example of a processing procedure in which the machine learning device according to the first example embodiment generates training data.

FIG. 10 is a flowchart showing an example of a processing procedure in which the analysis device according to the first example embodiment searches for the parameter value.

FIG. 11 is a diagram showing an example in which an updated parameter value selection unit according to a second example embodiment selects a candidate for an updated parameter value.

FIG. 12 is a flowchart showing an example of a processing procedure in which the machine learning device according to the second example embodiment learns a relationship between parameter values before and after the update and a ratio of a difference between evaluation target values.

FIG. 13 is a flowchart showing an example of a processing procedure in which an analysis device according to the second example embodiment searches for the parameter value.

FIG. 14 is a diagram showing an example of a configuration of an analysis device according to a third example embodiment.

FIG. 15 is a diagram showing an example of a configuration of a machine learning device according to a fourth example embodiment.

FIG. 16 is a diagram showing an example of a configuration of an analysis system according to a fifth example embodiment.

### EXAMPLE EMBODIMENT

Hereinafter, example embodiments of the present invention will be described, but the following example embodiments do not limit the inventions according to the claims. All combinations of features described in the example embodiments may not be essential to means for solving the invention.

### First Example Embodiment

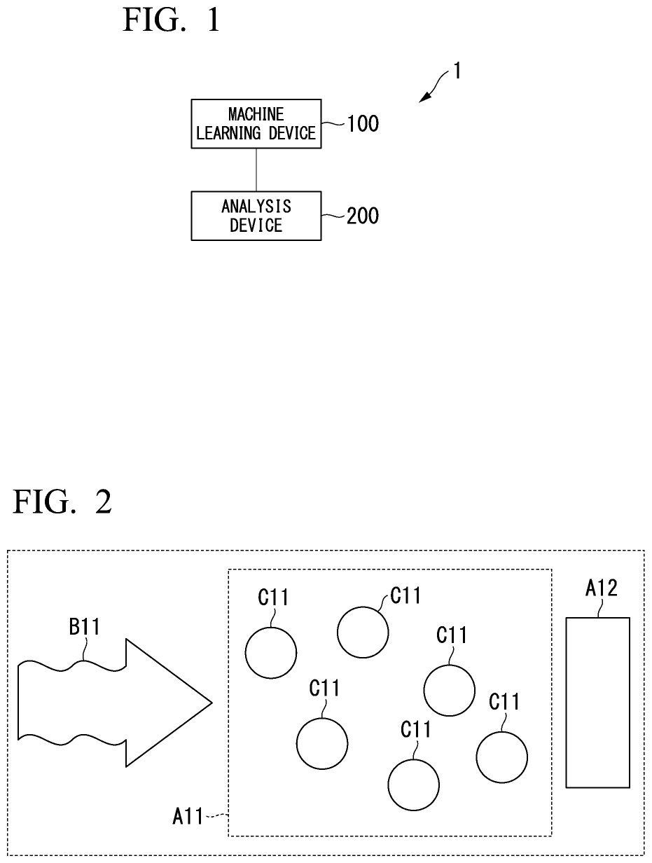

FIG. 1 is a schematic configuration diagram showing an example of a device configuration of an analysis system 1 according to a first example embodiment. With the configuration shown in FIG. 1, the analysis system 1 includes a machine learning device 100 and an analysis device 200.

The analysis system 1 performs machine learning on a relationship between an analysis target represented by a parameter (for example, a design target) and an evaluation target value determined according to a parameter value to search for a parameter value for an evaluation target value to satisfy a predetermined condition. The evaluation target value herein is a value used for evaluating the parameter value acquired by the analysis device 200 in the search as a solution of the search. In other words, the evaluation target value represents a value in which an interested event (event of interest) is quantitatively evaluated among events that occur with respect to the analysis target. The parameter is, for example, information representing a state related to the analysis target or a state in the analysis target. The analysis target is, for example, a flow velocity problem as shown in FIG. 2. The interested event is, for example, a flow velocity in a region A12. Details of the example of FIG. 2 will be described below.

The machine learning device 100 performs machine learning on the relationship between the parameter value of the analysis target and the evaluation target value. The machine learning device 100 acquires training data using a simulator that receives an input of the parameter value of the analysis target and outputs the evaluation target value to perform the machine learning.

The analysis device 200 uses the relationship, obtained by the machine learning, between the analysis target parameter value and the evaluation target value to search for the parameter value for the evaluation target value to satisfy the predetermined condition. The predetermined condition is, for example, a numerical value that quantitatively represents a desired condition regarding the analysis target (for example, design target). In a case where the analysis device 200 is applied to a design, the predetermined condition represents a condition that an index in which the interested event is quantitatively evaluated satisfies in a case where a desired design is performed with respect to the design target.

Both the machine learning device 100 and the analysis device 200 are configured by using a computer (information processing device) such as a personal computer (PC) or a workstation, for example. The machine learning device 100 and the analysis device 200 may be configured as the same device or may be configured as separate devices.

FIG. 2 is a diagram showing an example of a target of an analysis by the analysis system 1. FIG. 2 shows a design problem that determines a disposition of a cylinder C11.

In the design problem shown in FIG. 2, a predetermined number (for example, six) of cylinders C11 are disposed in a region A11. In this design problem, a fluid flows as shown by an arrow B11, and the disposition of the cylinders C11 is determined such that an average flow velocity of the fluid in a region A12 behind the region A11 is maximized. That is, in this example, the desired design is a design that obtains the disposition of the cylinders in a case where the average flow velocity of the fluid in the region A12 is maximized.

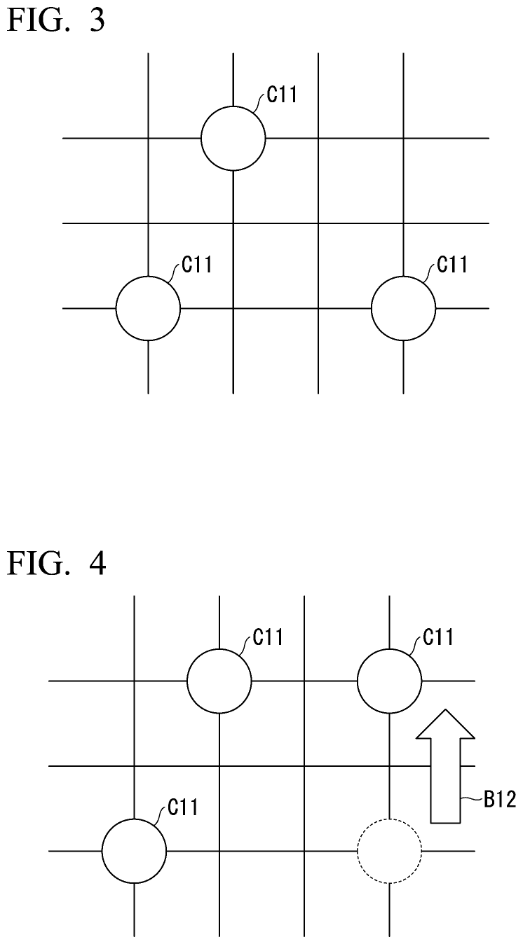

FIG. 3 is a diagram showing an example of setting a parameter in the target of the analysis by the analysis system 1. A grid is set in the region A11 in FIG. 2, and the cylinders C11 are disposed at grid points as shown in FIG. 3. A binary (two values of “1” or “0”) parameter variable is set for each grid point, and this parameter variable is used to indicate the presence or absence of the cylinder C11 for each grid point. With this, it is possible to indicate the disposition of the cylinder C11. In this example, “1” represents that the cylinder is disposed at the grid point. Further, “0” represents that no cylinder is disposed at the grid point.

In order to solve the design problem shown in FIGS. 2 and 3, it is assumed that a simulator for calculating the average flow velocity of the fluid in the region A12 in a case where the disposition of the cylinders C11 in the region A11 is determined can be used.

In this case, so to speak, an all-solution search method is considered in which the average flow velocity of the fluid in the region A12 is calculated by the simulator for each disposition of the cylinders C11 and the disposition in which the average flow velocity is maximized is obtained, as one of methods of solving the design problem. However, in this method, a so-called combinatorial explosion occurs as the number of grid points increases and the number of simulation executions becomes enormous. Therefore, it is considered that the design problem cannot be solved within a realistic time.

Thus, in the analysis system 1, the machine learning device 100 performs machine learning on the relationship between the input and the output in the simulation. The analysis device 200 uses learning results (learning model, score function, and the like) by the machine learning device 100, and thus it is not necessary to execute the simulation at the time of processing execution of the analysis device 200. Accordingly, it is possible to shorten a processing time of the entire analysis system 1. The learning results (learning model, score function, and the like) represent a relationship between the input and the output in the simulation. For example, the learning results (learning model, score function, and the like) are created in advance by applying a machine learning algorithm to the input in the simulation and the output in the simulation. As the machine learning algorithm, for example, a method such as a neural network or a support vector machine can be used.

The analysis system 1 can handle various problems that can be expressed by the parameter and in which machine learning can be performed on the execution of the simulation. In this respect, the analysis system 1 has a wide range of processing targets. It is possible to use the analysis system 1 in the design as in the design problem above, but it is not limited thereto.

FIG. 4 is a diagram showing an example of updating the parameter value in the analysis system 1.

In a state where the predetermined number of cylinders C11 are disposed at the grid points as described above, the disposition of one cylinder C11 is changed in one step of changing the disposition of the cylinder C11. This change is represented by an arrow B12 in FIG. 4. This one step is indicated by changing the parameter value of the grid point where the cylinder C11 is disposed from “1” to “0” and changing the parameter value of the grid point where the cylinder C11 is newly disposed from “0” to “1”, among the parameters for each grid point.

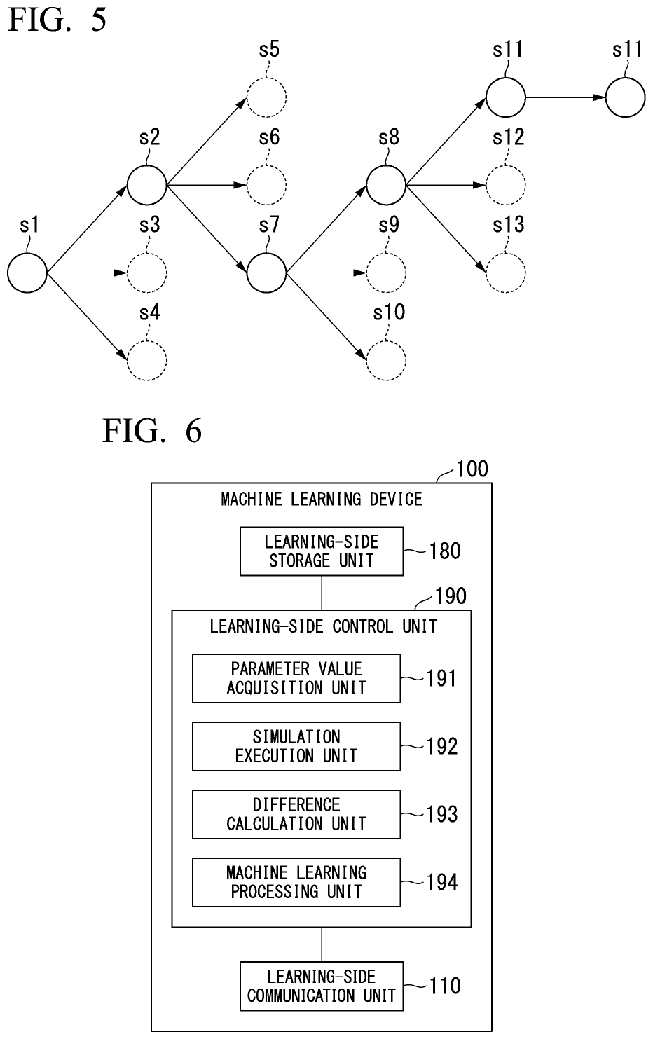

FIG. 5 is a diagram showing an example of searching for the parameter value by the analysis device 200.

Each of circles in FIG. 5 indicates a state of the analysis target indicated by the parameter value. The state of the analysis target indicated by the parameter value is simply referred to as a state. The parameter value and the state are associated one-to-one. FIG. 5 shows states s1 to s13.

In an initial setting, the analysis device 200 disposes the predetermined number of cylinders C11 at the grid points, for example, randomly. The state in this initial setting is indicated by the state s1 in FIG. 5.

The analysis device 200 randomly changes the disposition of the cylinder C11 so as to satisfy the condition of one step of changing the disposition of the cylinder C11 described above and generates a plurality of candidates for an updated state. The candidate for the updated state is associated with a candidate for an updated parameter value on a one-to-one basis. In the following, the candidate for the updated state and the candidate for the updated parameter value are equated and are also simply referred to as candidates.

FIG. 5 shows an example of a case where the analysis device 200 generates three candidates for the updated state. The analysis device 200 generates three states of the states s2, s3, and s4 as the candidate for the update from the state s1.

The analysis device 200 uses the machine learning result by the machine learning device 100 to calculate the evaluation target value for each of the generated candidates and uses the obtained evaluation target value as a selection index value to select any one of the candidates. The selection index value herein is a value used by the analysis device 200 to select any one of the candidates. The analysis device 200 calculates the selection index value for each candidate. The analysis device 200 selects the state s2 among the states s2, s3, and s4 in the example of FIG. 5.

In the first example embodiment, the analysis device 200 selects a candidate having the highest evaluation in the selection index value among the generated candidates. In the case of the above design problem, the average flow velocity of the fluid in the region A12 is the evaluation target value. In this example, since the selection index value is the evaluation target value, the analysis device 200 selects a candidate having the fastest average flow velocity.

The analysis device 200 repeatedly generates and selects the candidate for the updated state to search for the parameter value. The analysis device 200 repeats the generation and selection of the candidate for the updated state until a predetermined end condition is satisfied. For example, in the above design problem, the analysis device 200 repeats the generation and selection of the candidate for the updated states until the average flow velocity of the fluid in the region A12 becomes equal to or larger than a predetermined threshold value.

In the example of FIG. 5, the end condition is satisfied in the state s11, and the analysis device 200 acquires the parameter value in the state s11 as a processing result.

FIG. 6 is a schematic block diagram showing an example of a functional configuration of the machine learning device 100. With the configuration shown in FIG. 6, the machine learning device 100 includes a learning-side communication unit 110, a learning-side storage unit 180, and a learning-side control unit 190. The learning-side control unit 190 includes a parameter value acquisition unit 191, a simulation execution unit 192, a difference calculation unit 193, and a machine learning processing unit 194.

The learning-side communication unit 110 communicates with another device. The learning-side communication unit 110 may transmit the learning result by the machine learning device 100 to the analysis device 200.

The learning-side storage unit 180 stores various types of data. The learning-side storage unit 180 is configured by using a storage device included in the machine learning device 100.

The learning-side control unit 190 controls each unit of the machine learning device 100 to perform various pieces of processing. A function of the learning-side control unit 190 can be executed by a central processing unit (CPU) included in the machine learning device 100 reading a program from the learning-side storage unit 180 and executing the program.

The parameter value acquisition unit 191 acquires an update target parameter value and an updated parameter value. Both the update target parameter value and the updated parameter value are values that can be taken by the parameter in the problem targeted by the analysis device 200. The update target parameter value and the updated parameter value become parts of the training data for the machine learning device 100 to perform the machine learning.

The parameter value acquisition unit 191 may randomly set the update target parameter value according to a condition of parameter value setting. The parameter value acquisition unit 191 may randomly update the update target parameter value according to a condition of parameter value update to generate the updated parameter value.

Alternatively, the parameter value acquisition unit 191 may acquire predetermined update target parameter value and updated parameter value. For example, the learning-side storage unit 180 may store the update target parameter value and the updated parameter value set by a user, and the parameter value acquisition unit 191 may read the update target parameter value and the updated parameter value from the learning-side storage unit 180.

The simulation execution unit 192 calculates the evaluation target value in a case of each of the update target parameter value and the updated parameter value by simulation. In this case, the evaluation target value is obtained as a simulation output (prediction result by simulation).

The difference calculation unit 193 calculates a degree of difference of an evaluation target value in the case of the updated parameter value with respect to an evaluation target value in the case of the update target parameter value. Specifically, the difference calculation unit 193 calculates, for example, a difference obtained by subtracting the evaluation target value in the case of the update target parameter value from the evaluation target value in the case of the updated parameter value. The difference calculation unit 193 divides the calculated difference by the evaluation target value in the case of the update target parameter value to perform normalization. A value after the normalization is referred to as a ratio of the difference between the evaluation target values.

The machine learning processing unit 194 performs machine learning on a relationship between: the update target parameter value and the updated parameter value; and the degree of difference between the evaluation target values. Specifically, the machine learning processing unit 194 performs machine learning on a relationship between: the update target parameter value and the updated parameter value; and the ratio of the difference between the evaluation target values.

A machine learning method used by the machine learning processing unit 194 is not limited to a specific method. For example, the machine learning processing unit 194 may perform the machine learning by a method such as so-called deep learning, but it is not limited thereto.

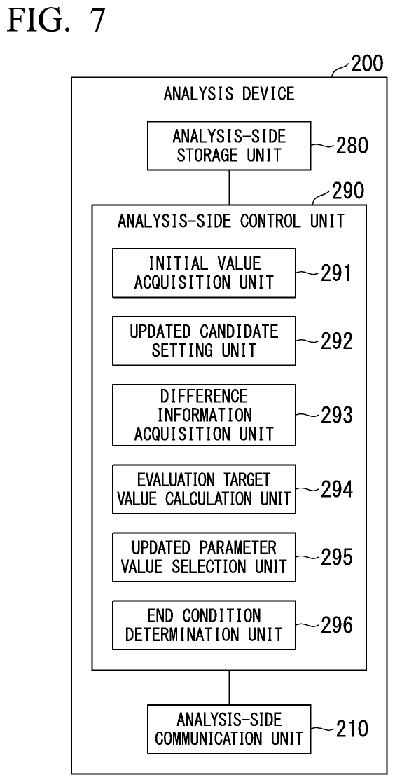

FIG. 7 is a schematic block diagram showing an example of a functional configuration of the analysis device 200. With the configuration shown in FIG. 7, the analysis device 200 includes an analysis-side communication unit 210, an analysis-side storage unit 280, and an analysis-side control unit 290. The analysis-side control unit 290 includes an initial value acquisition unit 291, an updated candidate setting unit 292, a difference information acquisition unit 293, an evaluation target value calculation unit 294, an updated parameter value selection unit 295, and an end condition determination unit 296.

The analysis-side communication unit 210 communicates with another device. The analysis-side communication unit 210 may receive the learning result by the machine learning device 100 transmitted by the learning-side communication unit 110. The analysis-side storage unit 280 stores various types of data. The analysis-side storage unit 280 is configured by using a storage device included in the analysis device 200.

The analysis-side control unit 290 controls each unit of the analysis device 200 to perform various pieces of processing. A function of the analysis-side control unit 290 can be executed by a CPU included in the analysis device 200 reading a program from the analysis-side storage unit 280 and executing the program.

The initial value acquisition unit 291 acquires the update target parameter value and the evaluation target value in the case of the update target parameter value. The update target parameter value acquired by the initial value acquisition unit 291 is used as an initial value of the parameter in a case where the analysis device 200 searches for the parameter value. The evaluation target value in the case of the update target parameter value acquired by the initial value acquisition unit 291 is used to convert the ratio of the difference between the evaluation target values obtained from the learning result by the machine learning device 100 into the evaluation target value. The initial value acquisition unit 291 uses, for example, the simulation by the simulation execution unit 192 of the machine learning device 100 to acquire the evaluation target value in the case of the update target parameter value.

The initial value acquisition unit 291 may acquire a plurality of combinations of the update target parameter value and the evaluation target value in the case of the update target parameter value.

The analysis device 200 searches for the parameter value with the update target parameter value as the initial value of the parameter for each of the plurality of update target parameter values, and thus it is expected that a solution (parameter value) having a higher evaluation based on the evaluation target value can be obtained by another search even in a case where a local solution is found in some searches.

The updated candidate setting unit 292 sets a plurality of candidates for the updated parameter value. The updated candidate setting unit 292, for example, randomly updates the update target parameter value according to the condition of parameter value update to set the candidate for the updated parameter value.

The difference information acquisition unit 293 applies the update target parameter value and the candidate for the updated parameter value to the machine learning result by the machine learning device 100 for each candidate for the updated parameter value to acquire information indicating a degree of difference of the evaluation target value in the case of the candidate for the updated parameter value with respect to the evaluation target value in the case of the update target parameter value. Specifically, the difference information acquisition unit 293 acquires, for example, the ratio of the difference between the evaluation target values. However, the degree of difference between the evaluation target values here is not limited to the ratio of the difference between the evaluation target values. For example, the difference information acquisition unit 293 may acquire information indicating a difference obtained by subtracting an evaluation value in a case of a candidate for the update target parameter value from the evaluation target value in the case of the candidate for the updated parameter value as the information indicating the degree of difference between the evaluation target values. Alternatively, the difference information acquisition unit 293 may acquire information indicating a ratio obtained by dividing the evaluation target value in the case of the candidate for the updated parameter value by the evaluation value in the case of the candidate for the update target parameter value as the information indicating the degree of difference between the evaluation target values.

The information indicating the degree of difference of the evaluation target value in the case of the candidate for the updated parameter value with respect to the evaluation target value in the case of the update target parameter value is referred to as difference information.

The evaluation target value calculation unit 294 calculates the evaluation target value in the case of the candidate for the updated parameter value based on the ratio of the difference between the evaluation target values and the evaluation target value in the case of the update target parameter value for each candidate for the updated parameter value.

The updated parameter value selection unit 295 selects a candidate having an evaluation target value that best matches a target among the candidates for the updated parameter value to update the update target parameter value the evaluation target value in the case of the update target parameter value to the selected candidate and an evaluation target value in the case of the selected candidate, respectively. In other words, the updated parameter value selection unit 295 compares the evaluation target values which are calculated for the candidates and selects the candidate based on the comparison result to update the update target parameter value and the evaluation target value in the case of the update target parameter value to the selected candidate and the evaluation target value in the case of the selected candidate, respectively.

The end condition determination unit 296 determines whether or not the evaluation target value in the case of the update target parameter value satisfies the predetermined end condition.

The analysis-side control unit 290 corresponds to an example of a repetition control unit and causes the processing of the updated candidate setting unit 292 and the subsequent processing to be repeated in a case where the end condition determination unit 296 determines that the evaluation target value in the case of the update target parameter value does not satisfy the predetermined end condition.

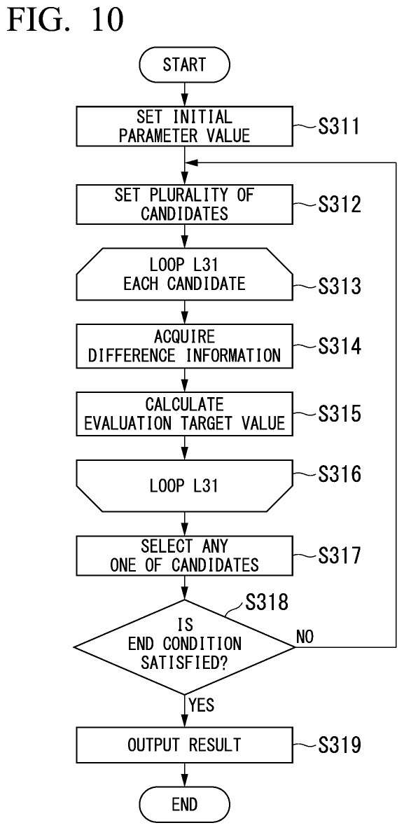

The processing of the updated candidate setting unit 292 and the subsequent processing herein include the following processing (1A) to (6A) as described below with reference to FIG. 10.

(1A) The updated candidate setting unit 292 sets the plurality of candidates for the updated parameter value.

(2A) The difference information acquisition unit 293 applies the update target parameter value and the candidate for the updated parameter value to the machine learning result for each candidate for the updated parameter value to acquire the information indicating the degree of difference of the evaluation target value in the case of the candidate for the updated parameter value with respect to the evaluation target value in the case of the update target parameter value.

(3A) The evaluation target value calculation unit 294 calculates, for each candidate for the updated parameter value, the evaluation target value in the case of the candidate for the updated parameter value based on the degree of difference between the evaluation target values and the evaluation target value in the case of the update target parameter value.

(4A) The updated parameter value selection unit 295 selects the candidate having a selection index value (evaluation target value in this example) that best matches the target among the candidates for the updated parameter value to update the update target parameter value and the evaluation target value in the case of the update target parameter value to the selected candidate for the updated parameter value and the evaluation target value in the case of the selected candidate for the updated parameter value, respectively.

(5A) The end condition determination unit 296 determines whether or not the evaluation target value in the case of the update target parameter value satisfies the predetermined end condition.

(6A) The analysis-side control unit 290 causes the processing of (1A) to (6A) to be repeated until the end condition determination unit 296 determines that the evaluation target value in the case of the update target parameter value satisfies the predetermined end condition in (5A) above.

Here, the processing performed by the analysis system 1 is formulated.

A value of the parameter of the analysis target is indicated by X. The parameter value X may be a combination of a plurality of parameter values and is indicated by a vector. Elements of the parameter value X, that is, individual parameter values are expressed as b₁, b₂, . . . , bₙ (n is a positive integer indicating the number of parameters). The parameter value X is indicated by a vector as shown in equation (1).

[Equation 1]

X=(b₁,b₂, . . . ,bₙ) (1),

A simulation output in a case where the parameter value X is input into the simulator of the simulation execution unit 192 is expressed as Yₛᵢₘ. The simulation output Yₛᵢₘ is indicated by equation (2).

[Equation 2]

Yₛᵢₘ=Fₛᵢₘ(X) (2)

Fₛᵢₘ schematically represents the simulation executed by the simulation execution unit 192 as a function.

The parameter value obtained by updating the parameter value X is expressed as the parameter value X′. The parameter value X corresponds to the update target parameter value. The parameter value X′ corresponds to the updated parameter value. The parameter value X′ is obtained by updating the parameter value X according to a predetermined update condition (constraint condition) for updating the parameter value.

The parameter value X′ is indicated by a vector as in the case of the parameter value X. Elements of the parameter value X′, that is, individual parameter values are expressed as b′₁, b′₂, . . . , b′ₙ (n is a positive integer indicating the number of parameters). The parameter value X′ is indicated by a vector as shown in equation (3).

[Equation 3]

X′=(b′₁,b′₂, . . . ,b′ₙ) (3)

A simulation output in a case where the parameter value X′ is input into the simulator of the simulation execution unit 192 is expressed as Y′ₛᵢₘ. The simulation output Y′ₛᵢₘ is indicated by equation (4).

[Equation 4]

Y′ₛᵢₘ=Fₛᵢₘ(X′) (4)

A difference of the simulation output Y′ₛᵢₘ with respect to the simulation output Yₛᵢₘ is represented as Y′ₛᵢₘ−Yₛᵢₘ.

A value normalized by dividing this difference by Yₛᵢₘ is expressed as a ratio Y of the difference between the evaluation target values. The ratio Y of the difference between the evaluation target values is indicated by equation (5).

$$[ Equation 5 ]$$

$$Y = \frac{Y {′}_{sim} - {Y}_{sim}}{{Y}_{sim}} \qquad ( 5 )$$

A prediction value based on the learning result performed by the machine learning processing unit 194 is expressed as μₛᵤᵣ. The μₛᵤᵣ is indicated by equation (6). As the prediction value μₛᵤᵣ, the ratio of the difference between the evaluation target values is obtained.

[Equation 6]

μₛᵤᵣ=Fₛᵤᵣ(X,X′) (6)

Fₛᵤᵣ represents the learning result used by the difference information acquisition unit 293 as a function. Equation (6) indicates that the prediction value μₛᵤᵣ are obtained by inputting the parameter value X and the updated parameter value X′ to the learning results (learning model and score function).

Using the above formulation, the example of the design problem of FIGS. 3 to 5 is indicated by the equation.

As described above, the binary is used as the elements (individual parameter values bᵢ) of the parameter value X in this case. The individual parameter value bᵢ is indicated by equation (7) as “1 □ i □ n (n is a positive integer indicating the number of parameters)”.

[Equation 7]

bᵢϵ{0,1} (7)

The individual parameter value bᵢ indicates the presence or absence of a cylinder at a position (grid point in this example) indicated by “i”. A case where the value of bᵢ is zero (bᵢ=0) indicates that the cylinder is not disposed at the position indicated by “i”. A case where the value of bᵢ is one (bᵢ=1) indicates that the cylinder is disposed at the position indicated by “i”.

The position indicated by “i” is expressed as a position of i.

The constraint condition that the number of cylinders is constant is indicated by equation (8).

$$[ Equation 8 ]$$

$${\sum }_{i = 1}^{n} {b}_{i} = M \qquad ( 8 )$$

M is a positive integer constant indicating the number of cylinders.

Here, the constraint condition in a case of updating the parameter value is to move any one of the cylinders. In a case where the cylinder at the position of i is moved to a position of j, the updated parameter value X is indicated by equation (9).

[Equation 9]

X′=(b₁,b₂, . . . ,bⱼ, . . . bᵢ, . . . ,bₙ) (9)

In a case where equation (1) is compared with equation (9), the bᵢ and bⱼ, are replaced in accordance with this movement. The analysis system 1 can perform the analysis by representing the analysis target such as the design problem using the parameters in this manner.

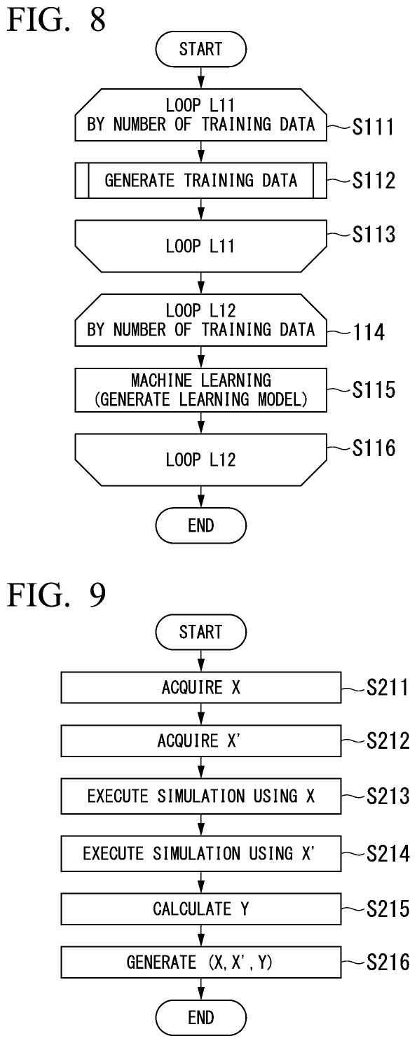

Next, an operation of the analysis system 1 will be described with reference to FIGS. 8 to 10.

FIG. 8 is a flowchart showing an example of a processing procedure in which the machine learning device 100 learns a relationship between the parameter values before and after the update and the ratio Y of the difference between the evaluation target values.

In processing of FIG. 8, the learning-side control unit 190 starts a loop L11 that repeats the processing by a predetermined number of training data (step S111).

In processing of loop L11, the learning-side control unit 190 generates the training data (step S112).

After step S112, the learning-side control unit 190 performs termination processing of the loop L11 (step S113). Specifically, the learning-side control unit 190 determines whether or not the number of repetitions of the processing of the loop L11 has reached the predetermined number of training data. In a case where determination is made that the number of repetitions has not reached the number of training data, the learning-side control unit 190 continues to repeat the processing of loop L11. On the other hand, in a case where determination is made that the number of repetitions has reached the number of training data, the learning-side control unit 190 ends the loop L11.

In a case where the loop L11 ends, the learning-side control unit 190 starts a loop L12 that repeats the processing by the number of training data (step S114).

In processing of the loop L12, the machine learning processing unit 194 performs the machine learning using the obtained training data (step S115).

After step S115, the learning-side control unit 190 performs termination processing of loop L12 (step S116). Specifically, the learning-side control unit 190 determines whether or not the number of repetitions of the processing of the loop L12 has reached a predetermined number of training data. In a case where determination is made that the number of repetitions has not reached the number of training data, the learning-side control unit 190 continues to repeat the processing of loop L12. On the other hand, in a case where determination is made that the number of repetitions has reached the number of training data, the learning-side control unit 190 ends the loop L12.

After the processing of the loop L12 ends, the machine learning device 100 ends the processing of FIG. 8.

FIG. 9 is a flowchart showing an example of a processing procedure in which the machine learning device 100 generates the training data. The machine learning device 100 performs processing of FIG. 9 in step S112 of FIG. 8.

In the processing of FIG. 9, the parameter value acquisition unit 191 acquires the parameter value X (step S211). The parameter value acquisition unit 191 may automatically generate the parameter value X, such as setting the parameter value X at random. Alternatively, the parameter value acquisition unit 191 may generate the parameter value X based on a user operation of inputting the parameter value X. Alternatively, the parameter value acquisition unit 191 may acquire the parameter value X from another device through the learning-side communication unit 110.

Next, the parameter value acquisition unit 191 acquires the parameter value X′ (step S212). The parameter value acquisition unit 191 may automatically generate the parameter value X′, such as updating the parameter value X at random within a range of the condition of updating the parameter value. Alternatively, the parameter value acquisition unit 191 may generate the parameter value X′ based on a user operation of inputting the parameter value X′. Alternatively, the parameter value acquisition unit 191 may acquire the parameter value X′ from another device through the learning-side communication unit 110.

Next, the simulation execution unit 192 executes the simulation using the parameter value X (step S213). Specifically, the simulation execution unit 192 inputs the parameter value X into the simulator included in the simulation execution unit 192 itself and executes the simulation to calculate the simulation output Yₛᵢₘ in the case of the parameter value X.

The simulation execution unit 192 executes the simulation using the parameter value X′ (step S214). Specifically, the simulation execution unit 192 inputs the parameter value X′ into the simulator included in the simulation execution unit 192 itself and executes the simulation to calculate the simulation output Y′ₛᵢₘ in the case of the parameter value X′.

Next, the difference calculation unit 193 calculates the ratio Y of the difference between the evaluation target values (step S215). Specifically, the difference calculation unit 193 performs the calculation of equation (5) described above using the simulation output Yₛᵢₘ and the simulation output Y′ₛᵢₘ to calculate the ratio Y of the difference between the evaluation target values.

The learning-side control unit 190 generates the training data in which the parameter value X, the parameter value X′, and the ratio Y of the differences between the evaluation target values are combined into one (step S216).

After step S216, the machine learning device 100 ends the processing of FIG. 9 and returns to the processing of FIG. 8.

FIG. 10 is a flowchart showing an example of a processing procedure in which the analysis device 200 searches for the parameter value.

In processing of FIG. 10, the initial value acquisition unit 291 sets the initial value of the parameter (step S311). The initial value acquisition unit 291 automatically sets the initial value of the parameter such as setting of the initial value of the parameter at random. Alternatively, the initial value acquisition unit 291 may set the initial value of the parameter based on a user operation of inputting the initial value of the parameter. Alternatively, the initial value acquisition unit 291 may acquire the initial value of the parameter from another device through the analysis-side communication unit 210.

The initial value of the parameter is used as the update target parameter value.

Next, the updated candidate setting unit 292 sets the plurality of candidates for the updated parameter value (step S312). The updated candidate setting unit 292 automatically generates the candidate for the updated parameter value, such as randomly updating the update target parameter value within the range of the condition of updating the parameter value.

Next, the analysis-side control unit 290 starts a loop L31 that performs processing for each candidate for the updated parameter value (step S313).

In the processing of loop L31, the difference information acquisition unit 293 acquires the information indicating the degree of difference of the evaluation target value in the case of the candidate for the updated parameter value with respect to the evaluation target value in the case of the update target parameter value (step S314). Specifically, the difference information acquisition unit 293 applies the update target parameter value and the candidate for the updated parameter value to the machine learning result to acquire the ratio of the difference between the evaluation target values.

The evaluation target value calculation unit 294 calculates the evaluation target value in the case of the candidate for the updated parameter value based on the obtained ratio of the difference between the evaluation target values and the evaluation target value in the case of the update target parameter value (step S315).

Next, the analysis-side control unit 290 performs termination processing of the loop L31 (step S316). Specifically, the analysis-side control unit 290 determines whether or not the processing of the loop L31 is performed on all candidates for the updated parameter value. In a case where determination is made that there is an unprocessed candidate, the analysis-side control unit 290 continues to repeat the processing of the loop L31. On the other hand, in a case where determination is made that the processing of the loop L31 has been executed for all the candidates, the analysis-side control unit 290 ends the loop L31.

In a case where the loop L31 is ended, the updated parameter value selection unit 295 selects any one of the candidates for the updated parameter value (step S317). For example, the updated parameter value selection unit 295 selects one candidate having an evaluation target value (selection index value in this example) that satisfies a predetermined target value or one candidate having an evaluation target value that is closest to the target value based on the evaluation target value (selection index value in this example) calculated by the difference information acquisition unit 293 for each candidate for the updated parameter value.

Next, the end condition determination unit 296 determines whether or not an end condition of the parameter value search is satisfied (step S318). For example, the end condition determination unit 296 determines whether or not the evaluation target value in the case of the parameter value selected in step S317 satisfies the target value, and determines that the end condition of the parameter value search is satisfied in a case where determination is made that it satisfies the target value.

In a case where the end condition determination unit 296 determines that the end condition of the parameter value search is not satisfied (step S318: NO), the processing transitions to step S312.

On the other hand, in a case where the end condition determination unit 296 determines that the end condition of the parameter value search is satisfied (step S318: YES), the analysis device 200 outputs a processing result (step S319). Specifically, the analysis device 200 presents the evaluation target value satisfying the target value and the parameter value at that time to the user as the processing result.

A method in which the analysis device 200 outputs the processing result is not limited to a specific method. For example, the analysis device 200 may include a display device to display the processing result. Alternatively, the analysis-side communication unit 210 may transmit the processing result to another device.

After step S319, the analysis device 200 ends the processing of FIG. 10.

As described above, the difference information acquisition unit 293 applies the update target parameter value and the candidate for the updated parameter value to the machine learning result for each of the plurality of candidates for the updated parameter value set according to the update target parameter value to acquire the information indicating the degree of difference of the evaluation target value in the case of the candidate for the updated parameter value with respect to the evaluation target value in the case of the update target parameter value. The evaluation target value calculation unit 294 calculates the evaluation target value in the case of the candidate for each candidate for the updated parameter value based on the degree of difference between the evaluation target values and the evaluation target value in the case of the update target parameter value. The updated parameter value selection unit 295 selects the candidate having the evaluation target value (in this example, the evaluation target value is used as the selection index value) that best matches the target among the candidates for the updated parameter value to update the update target parameter value and the evaluation target value in the case of the update target parameter value to the selected candidate and the evaluation target value in the case of the selected candidate, respectively. In other words, the updated parameter value selection unit 295 compares the evaluation target values which are calculated for the candidates for the updated parameter value and selects the candidate based on the comparison result to update the update target parameter value and the evaluation target value in the case of the update target parameter value to the selected candidate and the evaluation target value in the case of the selected candidate, respectively.

In this manner, with the analysis device 200, the candidate is selected by using the machine learning result in a case where a pattern having a high evaluation is selected from among a plurality of patterns by setting of the parameter value, and thus there is no need to execute the simulation in the case of selecting the candidate. In this respect, with the analysis device 200, it is possible to efficiently perform the analysis of selecting the pattern having the high evaluation from among the plurality of patterns. In particular, the processing time is shorter than in the case of executing the simulation in that the analysis device 200 acquires the evaluation target value using the machine learning result.

The analysis device 200 acquires the information indicating the degree of difference between the evaluation target values before and after the parameter value update from the machine learning result. The analysis device 200 can perform the analysis on various analysis targets having parameters and is relatively versatile. The analysis device 200 acquires a relative value that is the degree of difference between the evaluation target values from the machine learning result. In this respect, it is possible to reflect the evaluation target value in the case of the update target parameter value at the time of calculating the evaluation target value in the case of the candidate for the updated parameter value. It is considered that there is a relatively strong relationship (for example, correlation) in the degree of difference between the evaluation target values before and after the parameter value update. In this respect, with the analysis device 200, it is possible to calculate the evaluation target value with higher accuracy and to perform the analysis with higher accuracy.

The difference information acquisition unit 293 acquires the value normalized by dividing the difference of the evaluation target value in the case of the candidate for the updated parameter value with the evaluation target value in the case of the update target parameter value by the evaluation target value in the case of the update target parameter value, as the information indicating the degree of difference between the evaluation target values.

The analysis device 200 calculates the evaluation target value in the case of the candidate for the updated parameter value using the normalized difference between the evaluation target values. Therefore, it is possible to reflect more strongly a size of the evaluation target value in the case of the update target parameter value in a size of the evaluation target value in the case of the candidate for the updated parameter value than a case where non-normalized data is used. It is considered that the evaluation target values before and after the parameter value update have a relatively strong relationship (for example, correlation). In this respect, with the analysis device 200, it is possible to calculate the evaluation target value with higher accuracy.

However, the analysis system 1 may use a value other than the value normalized by dividing the difference of the evaluation target value in the case of the candidate for the updated parameter value with the evaluation target value in the case of the update target parameter value by the evaluation target value in the case of the update target parameter value, as the information indicating the degree of difference of the evaluation target value in the case of the candidate for the updated parameter value with respect to the evaluation target value in the case of the update target parameter value.

For example, the analysis system 1 may use a ratio between the evaluation target value in the case of the update target parameter value and the evaluation target value in the case of the candidate for the updated parameter value, as the information indicating the degree of difference of the evaluation target value in the case of the candidate for the updated parameter value with respect to the evaluation target value in the case of the update target parameter value.

Alternatively, the analysis system 1 may use a difference between the evaluation target value in the case of the update target parameter value and the evaluation target value in the case of the candidate for the updated parameter value, as the information indicating the degree of difference of the evaluation target value in the case of the candidate for the updated parameter value with respect to the evaluation target value in the case of the update target parameter value.

The parameter value acquisition unit 191 acquires the update target parameter value and the updated parameter value. The simulation execution unit 192 calculates the evaluation target value in a case of each of the update target parameter value and the updated parameter value by simulation. The difference calculation unit 193 calculates the degree of difference of the evaluation target value in the case of the updated parameter value with respect to the evaluation target value in the case of the update target parameter value. The machine learning processing unit 194 performs machine learning on the relationship between: the update target parameter value and the updated parameter value; and the degree of difference between the evaluation target values.

As described above, the machine learning device 100 performs the machine learning on the degree of difference between the evaluation target values, and thus it is possible to provide the analysis device 200 with the machine learning result that outputs the degree of difference between the evaluation target values.

The analysis device 200 can perform the analysis as described above by using the machine learning result.

### Second Example Embodiment

Each configuration of the analysis system 1, the machine learning device 100, and the analysis device 200 in a second example embodiment is similar to the case of the first example embodiment.

In the second example embodiment, the method in which the updated parameter value selection unit 295 of the analysis device 200 selects any one of the candidates for the updated parameter value is different from the case of the first example embodiment. The updated parameter value selection unit 295 according to the second example embodiment calculates a variation in the evaluation target values for each candidate for the updated parameter value and calculates the selection index value using the obtained variation to select the candidate. In the following, a case where the updated parameter value selection unit 295 uses variance as the variation in the evaluation target values will be described as an example, but it is not limited thereto. For example, the updated parameter value selection unit 295 may use a standard deviation as the variation in the evaluation target values.

In order to realize the candidate selection method by the updated parameter value selection unit 295, the machine learning device 100 generates a plurality of learning models.

The learning model herein is the result of the machine learning. Each of the learning models generated by the machine learning device 100 receives the input of the parameter value before the update and the updated parameter value, and outputs the ratio of the difference between the evaluation target values.

In order to realize the candidate selection method by the updated parameter value selection unit 295, the difference information acquisition unit 293 acquires the ratio of the difference between the evaluation target values for each learning model generated by the machine learning device 100.

In other respects, the analysis system 1 according to the second example embodiment is similar to the case of the first example embodiment.

The machine learning device 100 generates different training data sets in order to generate the plurality of learning models. The training data set herein is a set of training data used in one learning model. The machine learning device 100 may create the plurality of different learning models for one training data set. Such a machine learning device 100 can be realized, for example, by repeating processing of randomly selecting a plurality of training samples from a given training data set and creating the learning model for the selected plurality of training samples a plurality of times.

The individual training data included in the training data set is different for each training data set. Accordingly, the plurality of learning models generated by the machine learning device 100 receive the same value input and output different values for each learning model. Accordingly, it is possible to calculate the variance of the output of the learning model, and this variance can be used to select any one of the candidates for the updated parameter value.

The number of training data generated by the machine learning device 100 may be different for each learning model. Alternatively, the machine learning device 100 may generate the same number of training data for all learning models.

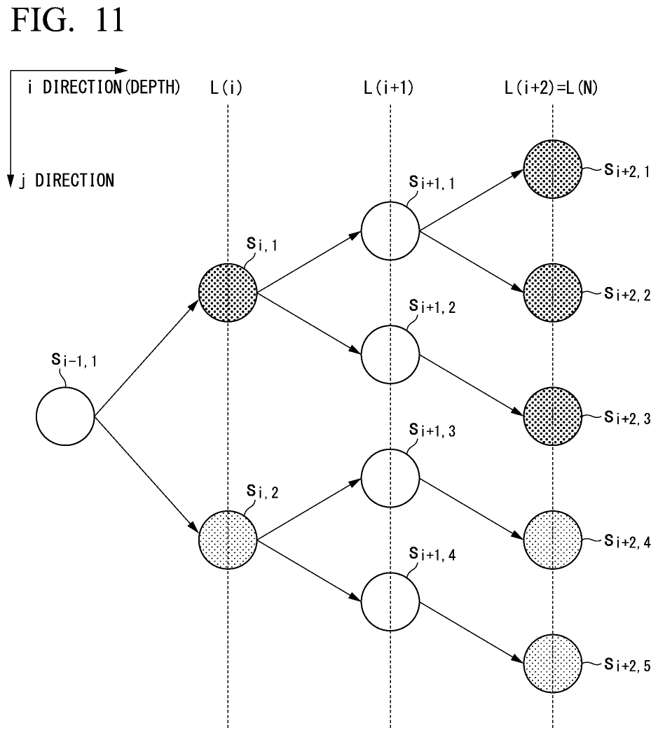

FIG. 11 is a diagram showing an example in which the updated parameter value selection unit 295 according to the second example embodiment selects the candidate for the updated parameter value.

In FIG. 11, i indicates progress of the search according to the number of updates of the parameter value. The number of updates of the parameter is indicated by LO. For example, an i-th update of the parameter value is expressed as “L(i)”.

In FIG. 11, j is an index for identifying a state at the number of updates of the same parameter value. As described above, each of the states is a state where the parameter value is set and is associated with the parameter value.

FIG. 11 shows an example in which the parameter value in a state s_{i-1,1} is updated to any one of the parameter value in a state s_{i,1} and the parameter value in a state so.

FIG. 11 shows an example in which look-ahead of the update of the parameter value is performed and the state in L(i) is selected based on state information in L(i+2).

In the following, the number of updates of the parameter value which is a state selection target is expressed as a depth L(i). Therefore, the number of updates before updating the parameter value is indicated as a depth L(i−1). The number of updates of the parameter value which is a look-ahead target is represented by a depth L(N). In the example of FIG. 11, “L(N)=L(i+2)”.

In the second example embodiment, the difference information acquisition unit 293 calculates the ratio of the difference between the evaluation target values by the number of learning models using the plurality of learning models for the parameter value in one state. In a case where there are a plurality of look-ahead destination states, the difference information acquisition unit 293 calculates the ratio of the difference between the evaluation target values by the number of “number of states×number of learning models”.

The evaluation target value calculation unit 294 calculates the evaluation target value for each ratio of the difference between the evaluation target values which are calculated by the difference information acquisition unit 293. The evaluation target value calculation unit 294 multiplies the ratio of the difference between the evaluation target values by an evaluation target value in a state corresponding to a parent node to convert the ratio of the difference into a difference. The evaluation target value calculation unit 294 adds the obtained difference to the evaluation target value in the state corresponding to the parent node to calculate the evaluation target value. The state corresponding to the parent node herein is a state immediately before in a depth direction (direction i).

In a case where the difference information acquisition unit 293 calculates the ratio of the difference, the processing of calculating the evaluation target value by the evaluation target value calculation unit 294 is indicated by equation (10).

[Equation 10]

G(s_{i,j})=G(s_{i-1,L})+G(s_{i-1,L})×μₛᵤᵣ(s_{i-1,L},s_{i,j}) (10)

G(S_{i,j}) indicates an evaluation target value of a calculation target (for example, evaluation target value in the case of the candidate for the updated parameter value). G(S_{i-1, L}) indicates an evaluation target value (for example, evaluation target value in the case of the update target parameter value) in the state corresponding to the parent node of the state of the evaluation target value calculation target. L indicates some constant.

μₛᵤᵣ(s_{i-1, L}, S_{i,j}) indicates the ratio of the difference between the evaluation target values.

The processing of calculating the evaluation target value by the evaluation target value calculation unit 294 is determined depending on the processing of the difference information acquisition unit 293. For example, in a case where the difference information acquisition unit 293 creates the difference information by the difference, the evaluation target value calculation unit 294 calculates a sum of the difference information and the evaluation target value in the state corresponding to the parent node. For example, in a case where the difference information acquisition unit 293 creates the difference information by the ratio, the evaluation target value calculation unit 294 calculates a product of the difference information and the evaluation target value in the state corresponding to the parent node.

The updated parameter value selection unit 295 calculates an average value and the variance of the evaluation target values which are calculated by the evaluation target value calculation unit 294 in a state corresponding to a descendant among the look-ahead target states for each candidate for the updated parameter value. In the case of the example of FIG. 11, the updated parameter value selection unit 295 calculates the average and the variance of all evaluation target values which are obtained in states s_{i+2,1}, s_{i+2,2}, and s_{i+2,3} for calculating the selection index value in the state s_{i,1}. The updated parameter value selection unit 295 calculates the average and the variance of all evaluation target values which are obtained in states s_{i+2,4} and s_{i+2,5} for calculating the selection index value in the state so.

In a case where the look-ahead is not performed, the updated parameter value selection unit 295 calculates the average and the variance of all the evaluation target values in the candidates themselves for the updated parameter value. As described above, it is possible to obtain the plurality of evaluation target values for one candidate for the updated parameter value by using the plurality of learning models.

The updated parameter value selection unit 295 calculates a selection index value of each candidate for the updated parameter value using equation (11), and selects one candidate having the largest selection index value.

$$[ Equation 11 ]$$

$${μ}_{i , j} + \sqrt{\frac{2 {δ}_{i , j}^{2}}{{n}_{N}^{i , j}} log {\sum }_{j = 1}^{k} {n}_{N}^{i , j}} \qquad ( 11 )$$

μ_{i,j} indicates the average value of the evaluation target values in the states corresponding to the descendant of a state s_{i,j} among states at the depth L(N). As described above, the depth L(N) is the depth of the look-ahead target. The state s_{i,j} is a candidate for the updated state (candidate for the updated parameter value). The descendant state of the state s_{i,j} is a node that can be reached by following a direction in which the number of updates of the parameter value from the state s_{i,j} increases.

δ_{i,j}² indicates the variance of the evaluation target values in the state corresponding to the descendant of the state s_{i,j} among the states at the depth L(N).

n_{N}^{i,j} indicates the number of states expanded at the depth L(N) which is the depth of the look-ahead target (the number of states corresponding to the descendant of the states s_{i,j}). In the example of FIG. 11, “n_{N}^{i,1}=3” and “n_{N}^{i,2}=2”.

k indicates the number of candidates for the updated parameter value. Therefore, k indicates the number of states at depth L(i). In the example of FIG. 11, “k=2”.

The value of equation (11) (the value obtained as a result of the calculation of equation (11)) corresponds to the example of the selection index value.

The updated parameter value selection unit 295 selects the candidate having the largest value of equation (11) from the candidates for the updated parameter value.

The value of equation (11) is increased as the number of states n_{N}^{i,j} corresponding to the descendant of the candidate for the updated parameter value is smaller (as the value is smaller). In a case where the number of states n_{N}^{i,j} corresponding to the descendant of the candidate for the updated parameter value is small, it is considered that the look-ahead from the candidate may not be sufficiently performed and a suitable state (state where the evaluation based on the evaluation target value is high) may be reached by performing further search. With equation (11), the candidate for the updated parameter value in this case is relatively easy to be selected.

The value of equation (11) is increased as a value of the variance δ_{i,j}² is larger. In a case where the value of the variance δ_{i,j}² is large, it is considered that the evaluation target value differs greatly for each state of the look-ahead destinations or an error of the evaluation target value due to the machine learning result is relatively large. In either case, it is considered that the suitable state may be reached by performing further search. With equation (11), the candidate for the updated parameter value in this case is relatively easy to be selected.

Alternatively, the updated parameter value selection unit 295 may calculate the selection index value of each of the candidates for the updated parameter value using equation (12) instead of equation (11), and may select one candidate having the largest selection index value.

$$[ Equation 12 ]$$

$${μ}_{i , j} + \sqrt{\frac{2 {V}_{k , {T}_{k} ( t - 1 )} \times {ϵ}_{{T}_{k} ( t - 1 ) , t}}{{T}_{k} ( t - 1 )}} + c \frac{3 b \times {ϵ}_{{T}_{k} ( t - 1 ) , t}}{{T}_{k} ( t - 1 )} \qquad ( 12 )$$

V_{k,Tk(t-1)} indicates a similar variance as δ_{i,j}² in equation (11).

ε_{Tk(t-1),t} indicates the number of states in L(N) which is the depth of the look-ahead target, similarly to Σ_{j=1,k}(n_{N}^{i,j}) in equation (11).

Tₖ(t−1) indicates the number of states corresponding to the descendant of the candidate of the updated parameter value, as with n_{N}^{i,j} in equation (11).

c indicates a hyperparameter that weights the third term.

b indicates a prediction width. The prediction width herein is a size of a value range of the average value μ_{i,j} of the evaluation target values.

The initial value acquisition unit 291 may acquire the plurality of combinations of the update target parameter value and the evaluation target value in the case of the update target parameter value, as in the case of the first example embodiment.

The analysis device 200 searches for the parameter value with the update target parameter value as the initial value of the parameter for each of the plurality of update target parameter values, and thus it is expected that a solution having a higher evaluation based on the evaluation target value can be obtained by another search even in a case where a local solution is found in some searches.

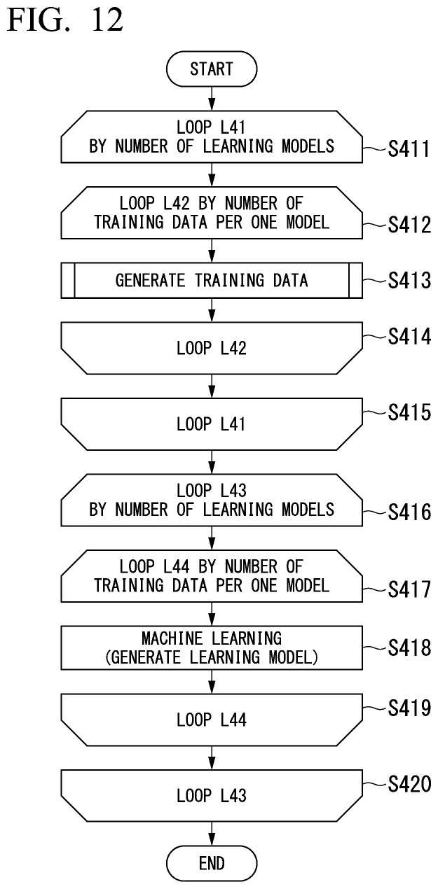

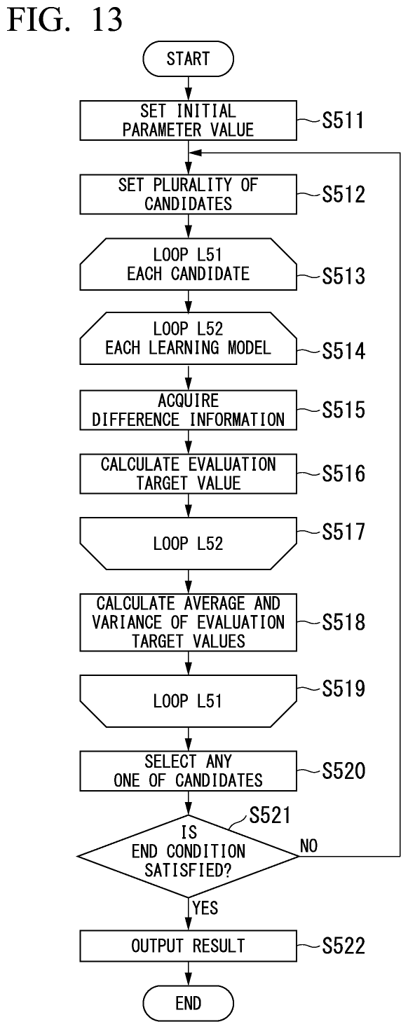

Next, an operation of the analysis system 1 according to the second example embodiment will be described with reference to FIGS. 12 to 13.

FIG. 12 is a flowchart showing an example of a processing procedure in which the machine learning device 100 learns a relationship between the parameter values before and after the update and the ratio of the difference between the evaluation target values.

In processing of FIG. 12, the learning-side control unit 190 starts a loop L41 that repeats the processing by the number of learning models to be generated (step S411).

Steps S412 to S414 are similar to steps S111 to S113 in FIG. 8. In step S413, the machine learning device 100 performs the processing of FIG. 9.

In steps S412 to S414, the machine learning device 100 generates training data for each learning model. That is, the processing procedure in which the machine learning device 100 according to the second example embodiment generates the training data for each learning model is similar to the processing procedure in which the machine learning device 100 according to the first example embodiment generates the training data.

After step S414, the learning-side control unit 190 performs termination processing of the loop L41. Specifically, the learning-side control unit 190 determines whether or not the training data set is generated by the number of learning models to be generated. In a case where determination is made that the number of generated training data sets is less than the number of learning models, the learning-side control unit 190 continues to repeat the processing of loop L41. On the other hand, in a case where determination is made that the training data set is generated by the number of learning models to be generated, the analysis-side control unit 290 ends the loop L41.

In a case where the loop L41 is ended, the learning-side control unit 190 starts a loop L43 that repeats the processing by the number of learning models to be generated (step S416).

Steps S417 to S419 are similar to steps S114 to S116 in FIG. 8. In steps S417 to S419, the machine learning device 100 generates the learning model. That is, the processing procedure in which the machine learning device 100 according to the second example embodiment generates the individual learning models is the same as the processing procedure in which the machine learning device 100 according to the first example embodiment generates the learning model.

After step S419, the learning-side control unit 190 performs termination processing of the loop L43. Specifically, the learning-side control unit 190 determines whether or not the number of learning models to be generated is generated. In a case where determination is made that the number of generated learning models is less than the number of learning models to be generated, the learning-side control unit 190 continues to repeat the processing of the loop L43. On the other hand, in a case where determination is made that the number of learning models to be generated is generated, the analysis-side control unit 290 ends the loop L43.

In a case where the loop L43 is ended, the machine learning device 100 ends the processing of FIG. 12.

FIG. 13 is a flowchart showing an example of a processing procedure in which the analysis device 200 searches for the parameter value.

Steps S511 to S513 are similar to steps S311 to S313 in FIG. 10.

In processing of a loop L51 started in step S513, the analysis-side control unit 290 starts a loop L52 that performs processing for each learning model (step S514).

In the processing of the loop L52, the difference information acquisition unit 293 acquires the information indicating the degree of difference of the evaluation target value in the case of the candidate for the updated parameter value with respect to the evaluation target value in the case of the update target parameter value (step S515). The evaluation target value calculation unit 294 calculates the evaluation target value of the candidate for the updated parameter value based on the obtained ratio of the difference between the evaluation target values and the evaluation target value in the case of the update target parameter value (step S516).

Steps S515 and S516 are similar to steps S314 and S315 of FIG. 10. That is, the processing in which the difference information acquisition unit 293 and the evaluation target value calculation unit 294 according to the second example embodiment obtain the evaluation target value for each learning model is similar to the processing in which the difference information acquisition unit 293 and the evaluation target value calculation unit 294 according to the first example embodiment obtain the evaluation target value.

In the case where there are the plurality of look-ahead destination states, in step S515, the difference information acquisition unit 293 acquires the information indicating the degree of difference of the evaluation target value in the case of the updated parameter value in the look-ahead destination state with respect to the evaluation target value in the case of the update target parameter value for each look-ahead destination state. In step S516, the evaluation target value calculation unit 294 calculates the evaluation target value for each look-ahead destination state.

After step S516, the analysis-side control unit 290 performs termination processing of loop L52 (step S517). Specifically, the analysis-side control unit 290 determines whether or not the loop L52 processing is performed for all the learning models. In a case where determination is made that there is an unprocessed learning model, the analysis-side control unit 290 continues to repeat the processing of the loop L52. On the other hand, in a case where determination is made that the processing of the loop L32 has been executed for all the learning models, the analysis-side control unit 290 terminates the loop L52.

In a case where the processing of the loop L52 ends, the updated parameter value selection unit 295 calculates the average value and the variance of the evaluation target values for each candidate for the updated parameter value (step S518).

Next, the analysis-side control unit 290 performs termination processing of the loop L51 (step S519). Specifically, the analysis-side control unit 290 determines whether or not the processing of the loop L51 is performed for all the candidates for the updated parameter value. In a case where determination is made that there is an unprocessed candidate, the analysis-side control unit 290 continues to repeat the processing of the loop L51. On the other hand, in a case where determination is made that the processing of the loop L51 has been executed for all the candidates, the analysis-side control unit 290 ends the loop L51. Step S519 is similar to step S316 in FIG. 10.

In a case where the loop L51 is ended, the updated parameter value selection unit 295 selects any one of the candidates for the updated parameter value (step S520). Specifically, the updated parameter value selection unit 295 uses the average and variance of the evaluation target values which are calculated for each candidate for the updated parameter value to select one candidate having the largest value of the equation (11) described above. As described above, the value of equation (11) corresponds to the example of the selection index value, and the updated parameter value selection unit 295 selects the candidate having the largest selection index value.

Next, the end condition determination unit 296 determines whether or not the end condition of the parameter value search is satisfied (step S521). For example, the analysis-side control unit 290 calculates the evaluation target value in the case of the selected parameter value as in the case of the first example embodiment. The end condition determination unit 296 determines whether or not the evaluation target value in the case of the selected parameter value satisfies the target value, and determines that the end condition of the parameter value search is satisfied in a case where determination is made that it satisfies the target value.

In a case where the end condition determination unit 296 determines that the end condition of the parameter value search is not satisfied (step S521: NO), the processing transitions to step S512. On the other hand, in a case where the end condition determination unit 296 determines that the end condition of the parameter value search is satisfied (step S521: YES), the analysis device 200 outputs the processing result (step S522). Step S522 is similar to step S319 in FIG. 10.

After step S522, the analysis device 200 ends the processing of FIG. 13.

As described above, the difference information acquisition unit 293 applies the update target parameter value and the candidate for the updated parameter value to a plurality of machine learning results for each of the plurality of candidates for the updated parameter value set according to the update target parameter value to acquire the information indicating the degree of difference of the evaluation target value in the case of the candidate for the updated parameter value with respect to the evaluation target value in the case of the update target parameter value for each machine learning result. The evaluation target value calculation unit 294 calculates the evaluation target value in the case of the candidate based on the degree of difference between the evaluation target values and the evaluation target value in the case of the update target parameter value for each candidate for the updated parameter value and for each machine learning result. The updated parameter value selection unit 295 selects a candidate having the selection index value calculated by using the variation in the plurality of evaluation target values for each candidate for the update target parameter value that is most suitable for a predetermined selection condition to update the update target parameter value and the evaluation target value in the case of the update target parameter value to the selected candidate and the evaluation target value in the case of the selected candidate, respectively. In other words, the updated parameter value selection unit 295 compares the selection index values calculated by using the variation in the plurality of evaluation target values for each candidate for the update target parameter value and selects a candidate based on the comparison result to update the update target parameter value and the evaluation target value in the case of the update target parameter value to the selected candidate and the evaluation target value in the case of the selected candidate, respectively.

In this manner, the analysis device 200 calculates the evaluation target value in the case of the candidate for the updated parameter value for each machine learning result using the plurality of machine learning results. Accordingly, the analysis device 200 can obtain the plurality of evaluation target values for one candidate for the updated parameter value, and the evaluation using the variation in the evaluation values becomes possible.

As described above, the value used by the analysis system 1 as an index indicating the variation in the evaluation target values is not limited to the variance of the evaluation target value. For example, the analysis system 1 may use a value other than the variance, such as using the standard deviation as the index indicating the variation in the evaluation target values.

The analysis device 200 acquires the information indicating the degree of difference between the evaluation target values at the time of updating the parameter value from the machine learning result. The analysis device 200 acquires a relative value that is the degree of difference between the evaluation target values from the machine learning result. In this respect, it is possible to reflect the evaluation target value in the case of the update target parameter value at the time of calculating the evaluation target value in the case of the candidate for the updated parameter value. It is considered that the evaluation target values before and after the parameter value update have a relatively strong relationship (for example, correlation). In this respect, with the analysis device 200, it is possible to calculate the evaluation target value with higher accuracy.

In the second example embodiment, the processing of the updated candidate setting unit 292 and the subsequent processing include the following processing (1B) to (6B).

(1B) The updated candidate setting unit 292 sets the plurality of candidates for the updated parameter value.

(2B) The difference information acquisition unit 293 applies the update target parameter value and the candidate for the updated parameter value to the plurality of machine learning results for each candidate for the updated parameter value to acquire the information indicating the degree of difference of the evaluation target value in the case of the candidate for the updated parameter value with respect to the evaluation target value in the case of the update target parameter value for each machine learning result.

(3B) The evaluation target value calculation unit 294 calculates the evaluation target value in the case of the candidate for the updated parameter value based on the degree of difference between the evaluation target values and the evaluation target value in the case of the update target parameter value for each candidate for the updated parameter value and for each machine learning result.

(4B) The updated parameter value selection unit 295 selects the candidate having the best evaluation in the evaluation using the average value and the variance (examples of the selection index value) of the evaluation target values for each of the candidates for the updated parameter value to update the update target parameter value and the evaluation target value in the case of the update target parameter value to the selected candidate and the evaluation target value in the case of the selected candidate, respectively.

(5B) The end condition determination unit 296 determines whether or not the evaluation target value in the case of the update target parameter value satisfies the predetermined end condition.

(6B) The analysis-side control unit 290 causes the processing of (1B) to (6B) to be repeated until the end condition determination unit 296 determines that the evaluation target value in the case of the update target parameter value satisfies the predetermined end condition in (5B) above.

The updated parameter value selection unit 295 gives a higher evaluation to a candidate having a larger variation (for example, variance) in the evaluation target values.

In a case where the variation in the evaluation target values is large, it is considered that the evaluation target value differs greatly for each state of the look-ahead destinations or an error of the evaluation target value due to the machine learning result is relatively large. In either case, it is considered that the suitable state may be reached by performing further search. With the analysis device 200, the candidate for the updated parameter value in this case is relatively easy to be selected.

The updated parameter value selection unit 295 selects the candidate having the selection index value, calculated by using the average value of the evaluation target values in addition to the variation in the evaluation target values, that is most suitable for the predetermined selection condition.

The updated parameter value selection unit 295 uses the selection index value based on the average value of the evaluation target values, and thus it is possible to reflect the average value of the evaluation target values in the selection of the candidate. The updated parameter value selection unit 295 preferentially selects a candidate having a large average value of the evaluation target values using this selection index value, and thus it is expected that the evaluation target value obtained for the selected candidate becomes large (evaluation is high).

The updated parameter value selection unit 295 performs the look-ahead of the update of the parameter value and gives a higher evaluation to a candidate having a small number of look-ahead parameter values.

For the candidate having a small number of look-ahead parameter values, it is considered that the evaluation by the look-ahead may not be sufficiently performed and a suitable state may be reached by performing further search. With the analysis device 200, the candidate for the updated parameter value in this case is relatively easy to be selected.

The difference information acquisition unit 293 acquires the value normalized by dividing the difference of the evaluation target value in the case of the candidate for the updated parameter value with respect to the evaluation target value in the case of the update target parameter value by the evaluation target value in the case of the update target parameter value, as the information indicating the degree of difference between the evaluation target values.

The analysis device 200 calculates the evaluation target value in the case of the candidate for the updated parameter value using the normalized difference between the evaluation target values. Therefore, it is possible to reflect more strongly a size of the evaluation target value in the case of the update target parameter value in a size of the evaluation target value in the case of the candidate for the updated parameter value than a case where non-normalized data is used. It is considered that the evaluation target values before and after the parameter value update have a relatively strong relationship (for example, correlation). In this respect, with the analysis device 200, it is possible to calculate the evaluation target value with higher accuracy.

However, the analysis system 1 may use a value other than the value normalized by dividing the difference of the evaluation target value in the case of the candidate for the updated parameter value with respect to the evaluation target value in the case of the update target parameter value by the evaluation target value in the case of the update target parameter value, as the information indicating the degree of difference of the evaluation target value in the case of the candidate for the updated parameter value with respect to the evaluation target value in the case of the update target parameter value.

For example, the analysis system 1 may use a ratio between the evaluation target value in the case of the update target parameter value and the evaluation target value in the case of the candidate for the updated parameter value, as the information indicating the degree of difference of the evaluation target value in the case of the candidate for the updated parameter value with respect to the evaluation target value in the case of the update target parameter value.

Alternatively, the analysis system 1 may use a difference between the evaluation target value in the case of the update target parameter value and the evaluation target value in the case of the candidate for the updated parameter value, as the information indicating the degree of difference of the evaluation target value in the case of the candidate for the updated parameter value with respect to the evaluation target value in the case of the update target parameter value.

The parameter value acquisition unit 191 acquires the update target parameter value and the updated parameter value. The simulation execution unit 192 calculates the evaluation target value in a case of each of the update target parameter value and the updated parameter value by simulation. The difference calculation unit 193 calculates the degree of difference of the evaluation target value in the case of the updated parameter value with respect to the evaluation target value in the case of the update target parameter value. The machine learning processing unit 194 uses, for example, a plurality of sets of the update target parameter value, the updated parameter value, and the degree of difference between the evaluation target values to acquire the plurality of machine learning results of the relationship between: the update target parameter value and the updated parameter value; and the degree of difference between the evaluation target values.

As described above, the machine learning device 100 performs the machine learning on the degree of difference between the evaluation target values, and thus it is possible to provide the analysis device 200 with the machine learning result that outputs the degree of difference between the evaluation target values.

The analysis device 200 can perform the analysis as described above by using the machine learning result.

The machine learning device 100 acquires the plurality of machine learning results, and thus the analysis device 200 can acquire the plurality of evaluation target values using the plurality of machine learning results and can acquire the index indicating the magnitude of the variation in the evaluation target values such as the variance of the evaluation target values. The analysis device 200 can evaluate the parameter value using the index indicating the magnitude of the variation in the evaluation target values, and thus it is expected to be able to detect a search region having a large evaluation target value (high evaluation).

A Bayesian neural network may be used for the machine learning by the machine learning device 100. The Bayesian neural network outputs with a probability distribution. The analysis device 200 can obtain the average value and the variance of the evaluation target values from the output of the Bayesian neural network, and thus it is not necessary to separately calculate the average value and the variance.

The Bayesian neural network will be described using equations.

The training data set is represented by equation (13) with the number of training data as M (M is a positive integer) and individual training data as (i is an integer of 1 □ i □ M).

[Equation 13]

(ξ¹,ξ², . . . ,ξ^{M}) (13)

In equation (13), the training data set is represented by a vector in consideration of the order in which the training data is applied.

A k-th training data ξ^{k} is indicated by equation (14).

[Equation 14]

ξ^{k}=(y^{k},x^{k}) (14)

y^{k} indicates an output value of the neural network in the k-th training data ξ^{k}. x^{k} indicates an input value to the neural network in the k-th training data ξ^{k}.

In a case where each feature is expressed as xᵢ^{k} (i is an integer of 1≤i≤n) with the number of features (number of elements) in x^{k} as n, x^{k} is indicated by equation (15).

[Equation 15]

x^{k}=(x₁^{k}, . . . ,xₙ^{k}) (15)

It is assumed that a likelihood function is represented by L and the likelihood is indicated by equation (16).

[Equation 16]

L(ξ¹, . . . ,ξ^{M}|θ) (16)

L represents the likelihood function. θ is a hyperparameter and follows a distribution π(θ) as in equation (17).

[Equation 17]

θ˜π(θ) (17)

π(θ) indicates a prior probability density function.

A new prediction (prediction other than the learning data) is expressed as a prediction of an output value y^{M+1} from an input value x^{M+1} and is indicated by equation (18) from the Bayes' theorem.

[Equation 18]

p(y^{M+1}|x^{M+1},ξ¹, . . . ,ξ^{M})=∫p(y^{M+1}|x^{M+1},θ)π(θ|ξ¹, . . . ,ξ^{M})dθ (18)

Both p and p indicate a conditional probability density distribution (likelihood function). π(θ|ξ) indicates a posterior probability density function.

p(y^{M+1}|x^{M+1},θ) is treated as a neural network model. The hyperparameter θ is assumed to be in accordance with equation (19).

[Equation 19]

θ=(β,σ²) (19)

A normal distribution N(βₚ′,σₚ′) is assumed as π(β), and a non-informative prior distribution is assumed as π(σₚ). Each of βₚ′ and σₚ′ indicates a certain value (real number constant).

From the Bayes' theorem, it is indicated by equation (20).

$$[ Equation 20 ]$$

$$π ( β \vert {σ}^{2} , {ξ}^{1} , … , {ξ}^{M} ) ∝ L ( {ξ}^{1} , … , {ξ}^{M} \vert β , {σ}^{2} ) * {\prod }_{p = 1}^{s} π ( {B}_{p} ) \qquad ( 20 )$$

“∞” indicates proportionality.

The posterior distribution π(θ|ξ¹, . . . , ξ^{M}) is approximated from a parameter set θ(i)=(β⁽ⁱ⁾,σ²⁽ⁱ⁾) obtained using a Metropolis-Hastings algorithm. The superscript “(i)” is an index indicating a sampling time.

That is, θ⁽ⁱ⁾=(β⁽ⁱ⁾,σ²⁽ⁱ⁾) is obtained (excluding a part of convergence assumption of the Metropolis-Hastings algorithm) and discrete approximation is performed.

Similarly, p(y^{M+1}|x^{M+1},θ) is also discretely approximated by θ⁽ⁱ⁾.

Returning to equation (16), p(y^{M+1}|x^{M+1},θ) is treated as the neural network model as described above, and thus the probability distribution (approximation) of the prediction value can be obtained.

Here, the processing time by the analysis system 1 according to the second example embodiment is indicated by equation (21).

[Equation 21]

Tₛᵢₘ×N_{data}+T_{Lrn}+{(D×Tₛᵤᵣ×N_{model})×N_{play}}×L (21)

Tₛᵢₘ indicates a calculation time per simulation execution.

N_{data} indicates the number of input data to the simulator (hence, the number of times the simulation is executed) for the machine learning device 100 to perform the machine learning.

A time required for data generation is Tₛᵢₘ×N_{data}.

T_{Lrn} indicates a time required for the machine learning device 100 to perform the machine learning. The time required for the machine learning device 100 to perform the machine learning is proportional to the time required for the data generation. T_{Lrn} ∝Tₛᵢₘ×N_{data}.

D indicates the depth of the look-ahead performed by the analysis device 200.

Tₛᵤᵣ indicates a calculation time per one state and per one learning model.

N_{model} indicates the number of learning models used by the analysis device 200.

N_{play} indicates the number of states (number of playouts) corresponding to the descendant when a maximum depth of the look-ahead is reached.

L indicates a final depth.

The calculation time in a case where similar processing is performed by executing the simulation without performing the machine learning is indicated by equation (22).

[Equation 22]

{(D×Tₛᵢₘ)×N_{play}}×L (22)

The calculation time in the case of performing the look-ahead in the same manner, performing similar processing in the execution of the simulation without performing the machine learning, and searching is indicated by equation (23).

[Equation 23]

Tₛᵢₘ×N_{node}^{D}×L (23)

N_{node}^{D} indicates the number of candidates for a next disposition place at the look-ahead depth.

For example, it is assumed that Tₛᵢₘ=2.0 [seconds], N_{data}=3000, N_{node}^{D}=390, Tₛᵢₘ×N_{data}=6112.5 [seconds], T_{Lrn}=20.0 [seconds], N_{model}=10, Tₛᵤᵣ=0.0037 [seconds], D=3, N_{play}=3900, and L=15. In this case, the calculation time required in each case is (a) approximately 209.5 minutes in the case of the analysis system 1 according to the second example embodiment (equation (21)), (b) approximately 5959.7 minutes (approximately 28.5 times the case of (a)) in a case where similar processing is performed by executing the simulation without performing the machine learning (equation (22)), and (c) approximately 20983.1 days (approximately 144256 times of (a)) in the case of performing the look-ahead in a similar manner, performing similar processing in the execution of the simulation without performing the machine learning, and searching (equation (23)).

In the processing of the case (b), the analysis device 200 proceeds with the search while narrowing down to any one of the plurality of candidates by similar processing to the case of (a). On the other hand, in the processing of (c), the analysis device 200 does not narrow down to one candidate and leaves a number of candidates up to N_{node}^{D}.

With the comparison of the calculation times of (a) to (c), the calculation time can be shortened in the case of the analysis system 1 according to the second example embodiment.

### Third Example Embodiment

An example of a configuration of an analysis device will be described in a third example embodiment.

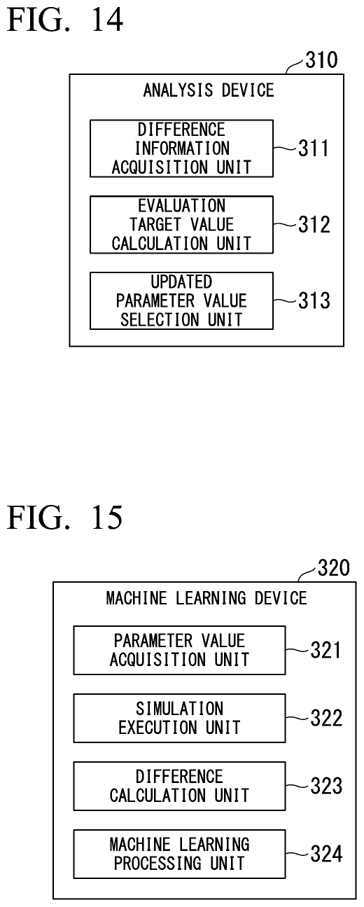

FIG. 14 is a diagram showing an example of the configuration of the analysis device according to the third example embodiment. An analysis device 310 shown in FIG. 14 includes a difference information acquisition unit 311, an evaluation target value calculation unit 312, and an updated parameter value selection unit 313.

With such a configuration, the difference information acquisition unit 311 applies the update target parameter value and the candidate for the updated parameter value to the machine learning result for each of the plurality of candidates for the updated parameter value set according to the update target parameter value to acquire the information indicating the degree of difference of the evaluation target value in the case of the candidate for the updated parameter value with respect to the evaluation target value in the case of the update target parameter value. The evaluation target value calculation unit 312 calculates the evaluation target value in the case of the candidate for the updated parameter value based on the degree of difference between the evaluation target values and the evaluation target value in the case of the update target parameter value for each candidate for the updated parameter value. The updated parameter value selection unit 313 compares the evaluation target values related to the candidates for the updated parameter value and selects the candidate based on the comparison result to update the update target parameter value and the evaluation target value in the case of the update target parameter value to the selected candidate and the evaluation target value in the case of the selected candidate, respectively. In other words, the updated parameter value selection unit 313 compares the evaluation target values which are calculated for the candidates for the updated parameter value and selects the candidate based on the comparison result to update the update target parameter value and the evaluation target value in the case of the update target parameter value to the selected candidate and the evaluation target value in the case of the selected candidate, respectively.

In this manner, with the analysis device 310, the candidate is selected by using the machine learning result in a case where a pattern having a high evaluation is selected from among a plurality of patterns by setting of the parameter value, and thus there is no need to execute the simulation in the case of selecting the candidate. In this respect, with the analysis device 310, it is possible to efficiently perform the analysis of selecting the pattern having the high evaluation from among the plurality of patterns. In particular, the processing time is shorter than in the case of executing the simulation in that the analysis device 310 acquires the evaluation target value using the machine learning result.

The analysis device 310 acquires the information indicating the degree of difference between the evaluation target values before and after the parameter value update from the machine learning result. The analysis device 310 can perform the analysis on various analysis targets having parameters and is relatively versatile. The analysis device 310 acquires a relative value that is the degree of difference between the evaluation target values from the machine learning result. In this respect, it is possible to reflect the evaluation target value in the case of the update target parameter value at the time of calculating the evaluation target value in the case of the candidate for the updated parameter value. It is considered that there is a relatively strong relationship (for example, correlation) in the degree of difference between the evaluation target values before and after the parameter value update. In this respect, with the analysis device 310, it is possible to calculate the evaluation target value with higher accuracy and to perform the analysis with higher accuracy.

### Fourth Example Embodiment

An example of a configuration of the machine learning device will be described in a fourth example embodiment.

FIG. 15 is a diagram showing an example of the configuration of the machine learning device according to the fourth example embodiment. The machine learning device 320 shown in FIG. 15 includes a parameter value acquisition unit 321, a simulation execution unit 322, a difference calculation unit 323, and a machine learning processing unit 324.

With such a configuration, the parameter value acquisition unit 321 acquires the update target parameter value and the updated parameter value. The simulation execution unit 322 calculates the evaluation target value in a case of each of the update target parameter value and the updated parameter value by simulation. The difference calculation unit 323 calculates the degree of difference of the evaluation target value in the case of the updated parameter value with respect to the evaluation target value in the case of the update target parameter value. The machine learning processing unit 324 performs machine learning on the relationship between: the update target parameter value and the updated parameter value; and the degree of difference between the evaluation target values.

As described above, the machine learning device 320 performs the machine learning on the degree of difference between the evaluation target values, and thus it is possible to provide the analysis device with the machine learning result that outputs the degree of difference between the evaluation target values. The analysis device can perform the analysis using this machine learning result.

### Fifth Example Embodiment

An example of a configuration of the analysis system will be described in a fifth example embodiment.

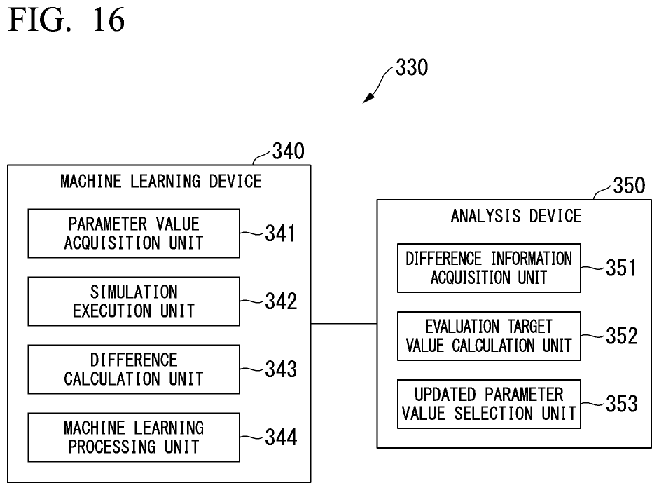

FIG. 16 is a diagram showing an example of the configuration of the analysis system according to the fifth example embodiment. An analysis system 330 shown in FIG. 16 includes a machine learning device 340 and an analysis device 350. The machine learning device 340 includes a parameter value acquisition unit 341, a simulation execution unit 342, a difference calculation unit 343, and a machine learning processing unit 344. The analysis device 350 includes a difference information acquisition unit 351, an evaluation target value calculation unit 352, and an updated parameter value selection unit 353.

With such a configuration, the parameter value acquisition unit 341 acquires the update target parameter value and the updated parameter value. The simulation execution unit 342 calculates the evaluation target value in a case of each of the update target parameter value and the updated parameter value by simulation. The difference calculation unit 343 calculates the degree of difference of the evaluation target value in the case of the updated parameter value with respect to the evaluation target value in the case of the update target parameter value. The machine learning processing unit 344 performs machine learning on the relationship between: the update target parameter value and the updated parameter value; and the degree of difference between the evaluation target values.

The difference information acquisition unit 351 applies the update target parameter value and the candidate for the updated parameter value to the machine learning result for each of the plurality of candidates for the updated parameter value set according to the update target parameter value to acquire the information indicating the degree of difference of the evaluation target value in the case of the candidate for the updated parameter value with respect to the evaluation target value in the case of the update target parameter value. The evaluation target value calculation unit 352 calculates the evaluation target value in the case of the candidate for the updated parameter value based on the degree of difference between the evaluation target values and the evaluation target value in the case of the update target parameter value for each candidate for the updated parameter value. The updated parameter value selection unit 353 compares the evaluation target values related to the candidates for the updated parameter value and selects the candidate based on the comparison result to update the update target parameter value and the evaluation target value in the case of the update target parameter value to the selected candidate and the evaluation target value in the case of the selected candidate, respectively. In other words, the updated parameter value selection unit 353 compares the evaluation target values which are calculated for the candidates for the updated parameter value and selects the candidate based on the comparison result to update the update target parameter value and the evaluation target value in the case of the update target parameter value to the selected candidate and the evaluation target value in the case of the selected candidate.

As described above, the machine learning device 340 performs the machine learning on the degree of difference between the evaluation target values, and thus it is possible to provide the analysis device 350 with the machine learning result that outputs the degree of difference between the evaluation target values.

With the analysis device 350, the candidate is selected by using the machine learning result in a case where one having a high evaluation is selected from among a plurality of patterns by setting of the parameter value, and thus there is no need to execute the simulation in the case of selecting the candidate. In this respect, with the analysis device 350, it is possible to efficiently perform the analysis of selecting the one having the high evaluation from among the plurality of patterns. In particular, the processing time is shorter than in the case of executing the simulation in that the analysis device 350 acquires the evaluation target value using the machine learning result.

The analysis device 350 acquires the information indicating the degree of difference between the evaluation target values before and after the parameter value update from the machine learning result. The analysis device 350 can perform the analysis on various analysis targets having parameters and is relatively versatile. The analysis device 350 acquires a relative value that is the degree of difference between the evaluation target values from the machine learning result. In this respect, it is possible to reflect the evaluation target value in the case of the update target parameter value at the time of calculating the evaluation target value in the case of the candidate for the updated parameter value. It is considered that there is a relatively strong relationship (for example, correlation) in the degree of difference between the evaluation target values before and after the parameter value update. In this respect, with the analysis device 350, it is possible to calculate the evaluation target value with higher accuracy and to perform the analysis with higher accuracy.

A computer-readable recording medium may record a program for executing all or part of the processing performed by the learning-side control unit 190 and the analysis-side control unit 290 and the program recorded on the recording medium may be read and executed by a computer system to perform the processing of each unit. The term “computer system” herein includes hardware such as an OS and a peripheral device.

The term “computer-readable recording medium” refers to a portable medium such as a flexible disk, a magneto-optical disk, a ROM, or a CD-ROM, or a storage device such as a hard disk built in a computer system. The above program may realize a part of the above functions or may further realize the above functions in combination with a program already recorded in the computer system.

Although the example embodiments of the present invention have been described in detail with reference to the drawings, the specific configuration is not limited to the example embodiments. The design and the like within a range without departing from the gist of the present invention are also included.

This application is based upon and claims the benefit of priority from Japanese patent application No. 2018-204014 filed on Oct. 30, 2018, the disclosure of which is incorporated herein in its entirety by reference.

### INDUSTRIAL APPLICABILITY

The present invention may be applied to an analysis device, a machine learning device, an analysis system, an analysis method, and a recording medium.

### REFERENCE SYMBOLS

1, 330: Analysis system
100, 320, 340: Machine learning device
110: Learning-side communication unit
180: Learning-side storage unit
190: Learning-side control unit
191, 321, 341: Parameter value acquisition unit
192, 322, 342: Simulation execution unit
193, 323, 343: Difference calculation unit
194, 324, 344: Machine learning processing unit
200, 310, 350: Analysis device
210: Analysis-side communication unit
280: Analysis-side storage unit
290: Analysis-side control unit
291: Initial value acquisition unit
292: Updated candidate setting unit
293, 311, 351: Difference information acquisition unit
294, 312, 352: Evaluation target value calculation unit
295, 313, 353: Updated parameter value selection unit
296: End condition determination unit

1. An analysis device comprising:
at least one memory configured to store instructions; and
at least one processor configured to execute the instructions to:
apply, for each of a plurality of candidates set according to a update target parameter value, the update target parameter value and the candidate to a machine learning result to acquire information, the information indicating a degree of difference of an evaluation target value in a case of the candidate with respect to an evaluation target value in a case of the update target parameter value;
calculate, for each candidate, an evaluation target value in a case of the candidate, based on the degree of difference of the evaluation target values and the evaluation target value in the case of the update target parameter value; and
compare the evaluation target values in a case of each of the plurality of candidates;
select a candidate from the plurality of candidates based on a result of the comparison; and
update the update target parameter value and the evaluation target value in the case of the update target parameter value to the selected candidate and the evaluation target value in the case of the selected candidate, respectively.

2. The analysis device according to claim 1, wherein the at least one processor is configured to execute the instructions to: acquire, for each of the plurality of candidates, a value normalized by dividing a difference of the evaluation target value in the case of the candidate with respect to the evaluation target value in the case of the update target parameter value by the evaluation target value in the case of the update target parameter value, as the information indicating the degree of difference of the evaluation target values.

3. A machine learning device comprising:
at least one memory configured to store instructions; and
at least one processor configured to execute the instructions to:
acquire an update target parameter value and an updated parameter value;
calculate, by simulation, an evaluation target value in a case of the update target parameter value and an evaluation target value in a case of the updated parameter value;
calculate a degree of difference of the evaluation target value in the case of the updated parameter value with respect to the evaluation target value in the case of the update target parameter value; and
perform machine learning on a relationship between: the update target parameter value and the updated parameter value; and the degree of difference of the evaluation target values.

4. An analysis system comprising:
a machine learning device; and
the analysis device according to claim 1,
wherein the machine learning device comprises:
at least one memory configured to store instructions; and
at least one processor configured to execute the instructions to:
acquire an update target parameter value and an updated parameter value;
calculate, by simulation, an evaluation target value in a case of the update target parameter value and an evaluation target value in a case of the updated parameter value;
calculate a degree of difference of the evaluation target value in the case of the updated parameter value with respect to the evaluation target value in the case of the update target parameter value; and
perform learning on a relationship between: the update target parameter value and the updated parameter value; and the degree of difference of the evaluation target values.

5. An analysis method executed by a computer, the method comprising:
applying, for each of a plurality of candidates set according to a update target parameter value, the update target parameter value and the candidate to a machine learning result to acquire information, the information indicating a degree of difference of an evaluation target value in a case of the candidate with respect to an evaluation target value in a case of the update target parameter value;
calculating, for each candidate, an evaluation target value in a case of the candidate, based on the degree of difference of the evaluation target values and the evaluation target value in the case of the update target parameter value;
comparing the evaluation target values in a case of each of the plurality of candidates;
selecting a candidate from the plurality of candidates based on a result of the comparison; and
updating the update target parameter value and the evaluation target value in the case of the update target parameter value to the selected candidate and the evaluation target value in the case of the selected candidate, respectively.

6. (canceled)
